(19) United States
(12) Patent Application Publication
(10) Pub. No.: US 2005/0125482 A1
(43) Pub. Date: Jun. 9, 2005

(54) Telecommunications assignment system

(76) Inventors: Lawrence E. Lyles, Snellville, GA (US); Andrew M. Kriebel, Acworth, GA (US); David Barnhurst, Bethlehem, GA (US); Greg DiMaggio, Powder Springs, GA (US); Stephen Phillips, Alpharetta, GA (US); Jerrard Curtis, Decatur, GA (US); Aimee Worley, Marietta, GA (US); Vincent Yen, Duluth, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/729,403

(22) Filed: Dec. 5, 2003

(51) Int. Cl. G06F 15/16

(52) U.S. Cl. 709/200

(57) ABSTRACT

A telecommunications assignment system is provided. The system typically includes assignment logic, collection logic and graphical user interface logic. The assignment logic assigns telecommunications equipment and ports to network elements. The collection logic receives the assignments from the assignment logic and stores the assignments in a database. The graphical user interface logic retrieves assignments from the database, and displays the assignments to a user in a graphical format. The graphical format includes displaying the telecommunications equipment substantially similar to the physical construction of the telecommunications equipment. Methods and other systems are also provided.

### TECHNICAL FIELD

The present disclosure is generally related to telecommunications and more particularly to assigning equipment in a telecom network.

### DESCRIPTION OF THE RELATED ART

The popularity of the internet and the proliferation of cellular phones has lead to an ever-increasing demand upon telecommunications networks. Most telecommunications carriers now offer networking solutions over their networks that range from business-type T1 access to consumer-type digital subscriber line and integrated services digital network (ISDN)-access to the internet. These solutions consume a seemingly ever-increasing amount of bandwidth on carrier networks. Moreover, cellular phones, while wireless from the user's perspective, also exhaust bandwidth on the wired networks of the carriers.

Such service typically necessitates an ever increasing complexity in the carrier's networks. However, this increasingly complex network should be tracked in order to accurately plan for future needs of customers and corporate expenditures on the network. Moreover, due to federal regulation, customer problems (trouble tickets) should be solved within a specified period of time. For this reason, telecommunications equipment typically includes telemetry equipment that recognizes events and signals alarms that are sent to a network reliability center (NRC). At the NRC there is typically a network monitoring and analysis (NMA) database which senses the alarms and creates a trouble ticket related to the alarm. However, the telemetry equipment used to collect alarms typically adds to the complexity of the network. It is difficult to accurately track the telecommunications network due to the complexity that exists within the network. Therefore, there is a need for systems and methods that address these and/or other perceived shortcomings of prior systems.

### SUMMARY OF THE DISCLOSURE

One preferred embodiment, among others, of the present disclosure provides for a telecommunications assignment system. A representative system, among others, includes assignment logic, collection logic and graphical user interface logic. The assignment logic is employed by a user to assign telecommunications equipment and ports to network elements. The collection logic receives assignments from the assignment logic and stores the assignments in a database. The graphical user interface logic retrieves assignments from the database, and displays the assignments to a user in a graphical format. The graphical format includes displaying the telecommunications equipment substantially similar to the physical construction of the telecommunications equipment.

Another preferred embodiment, among others, of the present disclosure provides methods for assigning telecommunications equipment. A representative method, among others, can include the following steps: providing a graphical user interface to a user, the graphical user interface comprising a plurality of telecommunications equipment and network elements which are displayed to the user in a format substantially similar to the physical construction of the telecommunications equipment, the graphical user interface being further operable to allow the user to make telecommunication equipment assignments; receiving telecommunications equipment assignments from the user via the graphical user interface; and, storing the telecommunications equipment assignments received from the user in a database for later retrieval.

Other systems, methods, and/or computer programs products according to embodiments will be or become apparent to one with skill in the art upon review of the following drawings and detailed description. It is intended that all such additional system, methods, and/or computer program products be included within this description, be within the scope of the present disclosure, and be protected by the accompanying claims.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram illustrating a telecommunications system including an embodiment, among others, of the present disclosure.

FIG. 1B is a block diagram illustrating the architecture of the telecommunications assignment system of FIG. 1A.

FIG. 1C is a block diagram illustrating the architecture of the user computer of FIG. 1A.

FIG. 2 is a screen shot of an embodiment, among others, of the telecommunications assignment system opening screen representation.

FIG. 3 is a flowchart illustrating the choices presented to the user upon the user selecting any of the menu representations shown in FIG. 2.

FIG. 4 is a screen shot of an embodiment, among others, illustrating a network element profile of the telecommunications assignment system of FIG. 1A.

FIG. 5 is a screen shot of an embodiment, among others, illustrating a “Site Information Screen” of the telecommunications assignment system of FIG. 1A.

FIG. 6 is a screen shot of an embodiment, among others, illustrating an “AI 180 Switch Configuration” screen of the telecommunications assignment system of FIG. 1A.

FIG. 7 is a screen shot of an embodiment, among others, illustrating an “AI 180 Switch Shelf” screen of the telecommunications assignment system of FIG. 1A.

FIG. 8 is a screen shot of an embodiment, among others, illustrating an add card screen of the telecommunications assignment system of FIG. 1A.

FIG. 9 is a screen shot of an embodiment, among others, illustrating a “COWAN” screen of the telecommunications assignment system of FIG. 1A.

FIG. 10 is a screen shot of an embodiment, among others, illustrating a “Router Configuration” screen of the telecommunications assignment system of FIG. 1A.

FIG. 11 is a screen shot of an embodiment, among others, illustrating a “Hub Info” screen of the telecommunications assignment system of FIG. 1A.

FIG. 12 is a screen shot of an embodiment, among others, illustrating a “Network Element Telemetry Assignment” screen of the telecommunications assignment system of FIG. 1A.

FIG. 13 is a screen shot of an embodiment, among others, illustrating a “Router Assignment” screen of the telecommunications assignment system of FIG. 1A.

FIG. 14 is a screen shot of an embodiment, among others, illustrating a “Hub Assignment” screen of the telecommunications assignment system of FIG. 1A.

FIG. 15 is a screen shot of an embodiment, among others, illustrating a “Patch Panel Assignment” screen of the telecommunications assignment system of FIG. 1A.

### DETAILED DESCRIPTION OF THE PREFERRED EMBODIMENTS

The disclosure now will be described more fully with reference to the accompanying drawings. The disclosure may, however, be embodied in many different forms and should not be construed as limited to the embodiments set forth herein; rather, these embodiments are intended to convey the scope of the disclosure to those skilled in the art. Furthermore, all “examples” given herein are intended to be non-limiting.

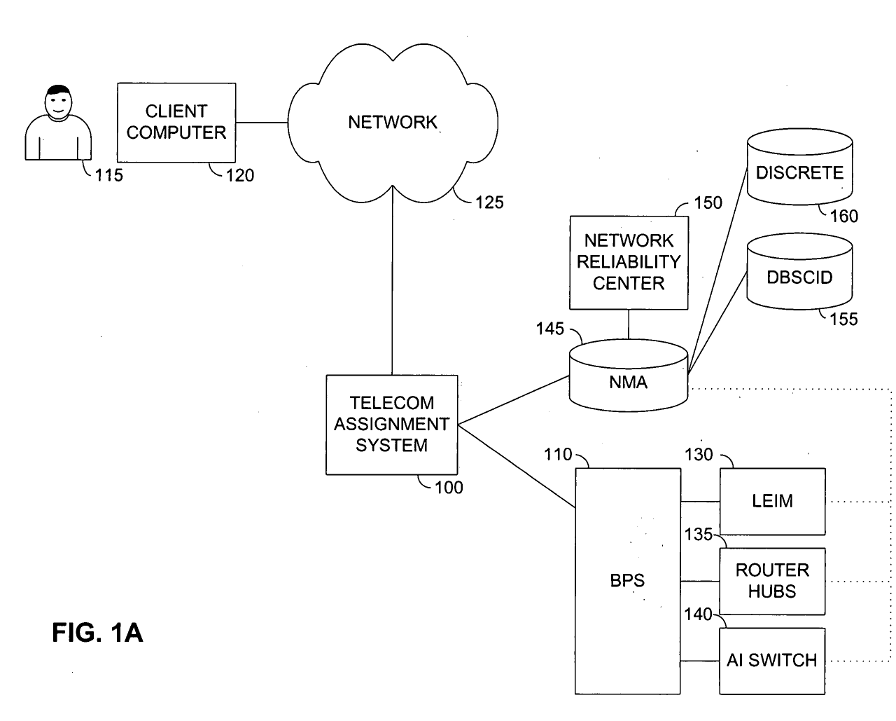

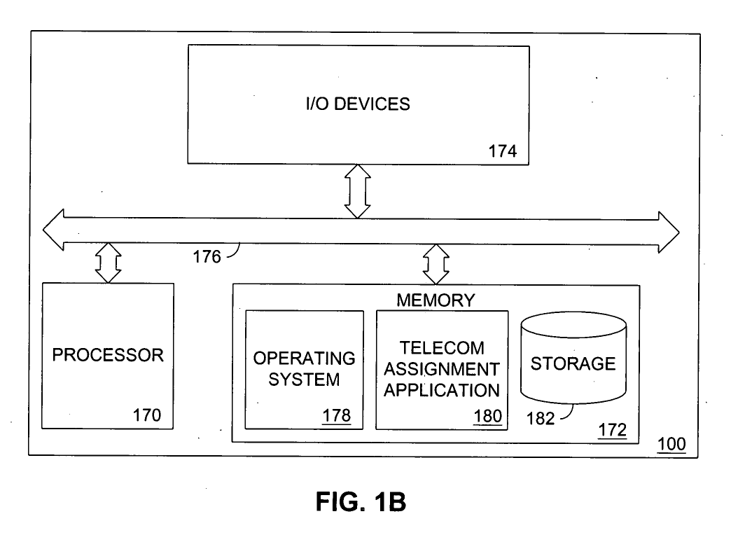

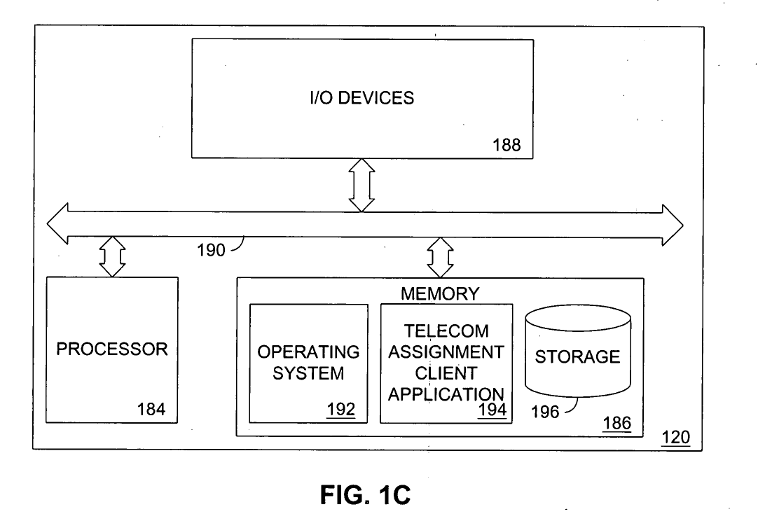

Referring to FIG. 1A, shown is a block diagram illustrating a system in which an embodiment, among others, of the present disclosure operates. The telecommunications assignment system 100 typically includes an application and a database at a data center, as shown in FIG. 1B. The database stores information regarding assignments for the numerous network elements such as a loop equipment inventory module (LEIM) 130, routers and hubs 135, or switches 140 that comprise the telecommunications network (not shown). The telecommunications assignment system 100 preferably communicates with the network elements 130-140 through a business process server 110 which operates to translate to the various protocols that are used by the different network elements 130-140 for the telecommunications assignment system 100.

A remote user 115 can typically access the telecommunications assignment system 100 using a computer 120 through a network 125. The network 125 is typically a secured intranet to prevent unapproved users from viewing or changing network assignments and settings. The computer 120 can typically include an application which would allow the user to view the telecommunications assignment system 100, as shown in FIG. 1C. In an embodiment, among others, of the disclosure, the application on computer 120 is a client application, and the telecommunications assignment system 100 includes a server application. The client application is operable to communicate requests for data and requests to modify data stored in the database to the server application. The server application is operable to query the database and provide data to the client and modify data in the database in response to requests received from the client. One such example would include configuring an Access database platform, available from Microsoft Corp., of Redmond, Wash., on the computer 120 to parse raw data received from the telecommunications assignment system 100 database.

However, one skilled in the art should also recognize that the client could alternatively run an application such as Citrix remote access client/server applications, available from Citrix of Fort Lauderdale, Fla., which allows the client computer 120 to remotely run applications and receive a graphical interface from the server. The graphical interface typically represents an emulation of a screen shot, and the client sends control signals to the server based upon input devices at the client computer 120. Thus, all of the database processing is performed at the server, and the client computer 120 is merely receiving the graphical interface information from the server which represents the applications running on the server. In such cases, the telecommunications assignment system 100 would run the application to be provided to the user.

Moreover, one skilled in the art should recognize that a web client (browser) could be used at the computer 120, and the telecommunications assignment system 100 could be a web server operable to send web pages to the web client via hypertext transfer protocol. One skilled in the art should appreciate that web pages could be coded in hypertext markup language (HTML), extensible markup language (XML), java or any other suitable transfer protocol. It should also be apparent to one skilled in the art that there exist numerous variations on the transfer protocol between the user 115 and the database, each of which are intended to be included within the present disclosure.

As mentioned above, the telecommunications equipment assignment system 100 is typically connected to a number of telecommunications devices 130, 135, 140 through a business process server 110. The telecommunication devices 130, 135, 140 are typically alarm collectors, which are operable to communicate alarms to a network monitoring and analysis database 145. The business process server 115 is typically operable to receive internet protocol (IP) packets from the telecommunications assignment system 100, and translate the packets to X.25 for alarm collectors coupled to the network. In alternative embodiments, the BPS 115 is further operable to translate the packets to asynchronous format for alarm collectors coupled to the network. The business process server can also receive, in various embodiments, X.25, asynchronous, IP or discrete alarm information from the alarm collectors and translate the information for the telecommunications assignment system 100. As is known in the art, X.25 is a communication protocol widely used in telecom networks, and typically occurs over a datakit network (not shown).

In some embodiments, among others, the alarm collectors 130, 135, 140 are in communication with a central office wide area network (COWAN) as well. The COWAN allows the alarm collectors to communicate alarms to a network monitoring and analysis (NMA) database 145 at a network reliability center (NRC) 150. The NMA database 145 further comprises a synchronous optical network (SONET) carrier identification (SCID) database 155 and a discrete database 160. The SCID database (DBSCID) 155 is typically operable to store information regarding alarms on a circuit identified by a SCID. The discrete database 160 is typically operable to store information regarding alarms collected by a discrete alarm collector from a network element. A discrete alarm typically has two states, on and off. The discrete alarm typically warns the NRC 150 that something is wrong with a network element, but typically does not give any indication of what the problem involves. For example, among others, a discrete alarm could indicate that a network element is down, but does not give an indication whether the problem is physical or logical. One skilled in the art should furthermore recognize that there are typically more than one NRC and NMA associated with a carrier network. Furthermore, one skilled in the art should recognize that the NMA database and the NRC typically create a trouble ticket upon receiving an alarm.

Referring now to FIG. 1B, shown is block diagram of the telecommunications assignment system 100 including an embodiment, among others, of the present disclosure. Generally, in terms of hardware architecture, as shown in FIG. 1B, the system 100 includes a processor 170, memory 172, and one or more input and/or output (I/O) devices 174 (or peripherals) that are communicatively coupled via a local interface 176. The local interface 176 can be, for example but not limited to, one or more buses or other wired or wireless connections, as is known in the art. The local interface 176 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 170 is a hardware device for executing software, particularly that stored in memory 172. The processor 170 can be any custom made or commercially available processor, a central processing unit (CPU), an auxiliary processor among several processors associated with the system 100, a semiconductor based microprocessor (in the form of a microchip or chip set), a macroprocessor, or generally any device for executing software instructions.

The memory 172 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 172 may incorporate electronic, magnetic, optical, and/or other types of storage media. Note that the memory 172 has a distributed architecture, in some implementations, where various components are situated remote from one another, but can be accessed by the processor 170.

The software in memory 172 includes one or more separate programs 178, 180, each of which comprises an ordered listing of executable instructions for implementing logical functions. In the example of FIG. 1B, the software in the memory 172 includes a telecommunications assignment application 180 and a suitable operating system (O/S) 178. A nonexhaustive list of examples of suitable commercially available operating systems 178 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; or (e) an appliance-based operating system, such as that implemented in handheld computers or personal data assistants (PDAs) (e.g., PalmOS available from Palm Computing, Inc., and Windows CE available from Microsoft Corporation). The operating system 178 essentially controls the execution of other computer programs, such as the telecommunications assignment application 180, and provides scheduling, input-output control, file and data management, memory management, and communication control and related services.

The telecommunications assignment application 180 includes, in various embodiments, source programs, executable program (object code), script, or any other entity comprising a set of instructions to be performed. When a source program, then the program needs to be translated via a compiler, assembler, interpreter, or the like, which may or may not be included within the memory 172, so as to operate properly in connection with the O/S 178. Furthermore, the telecommunications assignment application 180 is preferably written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. Alternatively, the telecommunications assignment application 180 can be written using hyper-text markup language. The telecommunications assignment application 180 would then provide the screens to the user at the remote computer 120 via the network.

The I/O devices 174 preferably include input devices, for example but not limited to, a keyboard, mouse, scanner, microphone, etc. Furthermore, the I/O devices 174 preferably include output devices, for example but not limited to, a printer, display, etc. Finally, the I/O devices 174 further preferably include devices that communicate both inputs and outputs, for instance but not limited to, a modulator/demodulator (modem; for accessing another device, system, or network), a radio frequency (RF) or other transceiver, a telephonic interface, a bridge, a router, etc.

If the telecommunications assignment system 100 is a PC, workstation, or the like, the software in the memory 172 may further include a basic input output system (BIOS) (omitted for simplicity). The BIOS is a set of essential software routines that initialize and test hardware at startup, start the O/S 178, and support the transfer of data among the hardware devices. The BIOS is stored in ROM so that the BIOS can be executed when the system 100 is activated.

When the telecommunication s assignment system 100 is in operation, the processor 170 is configured to execute software stored within the memory 172, to communicate data to and from the memory 172, and to generally control operations of the system 100 pursuant to the software. The telecommunications assignment application 180 and the O/S 178, in whole or in part, but typically the latter, are read by the processor 170, perhaps buffered within the processor 170, and then executed.

When the telecommunications assignment application 180 is implemented in software, as is shown in FIG. 1B, it should be noted that the telecommunications assignment application 180 can be stored on any computer readable medium for use by or in connection with any computer related system or method. Moreover, the telecommunications assignment application 180 can interact with a storage device 182 to store and retrieve information used in conjunction with the application 180. In the context of this document, a computer readable medium is an electronic, magnetic, optical, or other physical device or means that can contain or store a computer program for use by or in connection with a computer related system or method. The telecommunications assignment application 180 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

As described above, the telecommunications assignment system 100 is configured such that the application 180 provides a plurality of page representations to the user. These page representations are typically navigable via a telecommunications assignment client application running on the client computer 120, as described in FIG. 1C. In alternative embodiments, among others, the client application includes the page representations and merely receives data from the telecommunications assignment system 100.

Referring now to FIG. 1C, shown is a generic block diagram of the client computer 120 of FIG. 1A, including an embodiment, among others, of the present disclosure. Similarly to FIG. 1B, in terms of hardware architecture, as shown in FIG. 1C, the computer 120 includes a processor 184, memory 186, and one or more input and/or output (I/O) devices 188 (or peripherals) that are communicatively coupled via a local interface 190. Each of the elements in the computer are similar to those as described with respect to FIG. 1B, and as known in the art.

The software in memory 186 typically includes one or more separate programs 192, 194, each of which comprises an ordered listing of executable instructions for implementing logical functions. In the example of FIG. 1C, the software in the memory 186 includes a telecommunications assignment client application 194 and a suitable operating system (O/S) 192. Examples of suitable operating systems are the same as those described with respect to FIG. 1B.

The telecommunication assignment client application 194 is a source program, executable program (object code), script, or any other entity comprising a set of instructions to be performed. When a source program, then the program needs to be translated via a compiler, assembler, interpreter, or the like, which may or may not be included within the memory 186, so as to operate properly in connection with the O/S 192. Furthermore, the telecommunication assignment client application 194 in various implementations written as (a) an object oriented programming language, which has classes of data and methods, or (b) a procedure programming language, which has routines, subroutines, and/or functions, for example but not limited to, TCL/TK with Expect, C, C++, Pascal, Basic, Fortran, Cobol, Perl, Java, and Ada.

When the telecommunication assignment client application 194 is implemented in software, as is shown in FIG. 1C, it should be noted that the telecommunication assignment client application 194 in some implementations, among others, is stored on any computer readable medium for use by or in connection with any computer related system or method. In the context of this document, a computer readable medium is an electronic, magnetic, optical, or other physical device or means that contains or stores a computer program for use by or in connection with a computer related system or method. The telecommunication assignment client application 194 is typically embodied in any computer-readable medium for use by or in connection with an instruction execution system, apparatus, or device, such as a computer-based system, processor-containing system, or other system that fetches the instructions from the instruction execution system, apparatus, or device and execute the instructions. In the context of this document, a “computer-readable medium” is any means that can store, communicate, propagate, or transport the program for use by or in connection with the instruction execution system, apparatus, or device. The computer readable medium is, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium in some embodiments, among others, is paper or another suitable medium upon which the program is printed, as the program is operable to be electronically captured, via for instance optical scanning of the paper or other medium, then compiled, interpreted or otherwise processed in a suitable manner if necessary, and then stored in a computer memory.

The telecommunications assignment client application 194 is typically operable to receive information from the telecommunications assignment application 180 and render it on the remote computer 120 for a user. Moreover, the telecommunications assignment client application 194 is operable to receive instructions from the user and relay the instructions to the telecommunications assignment application 180.

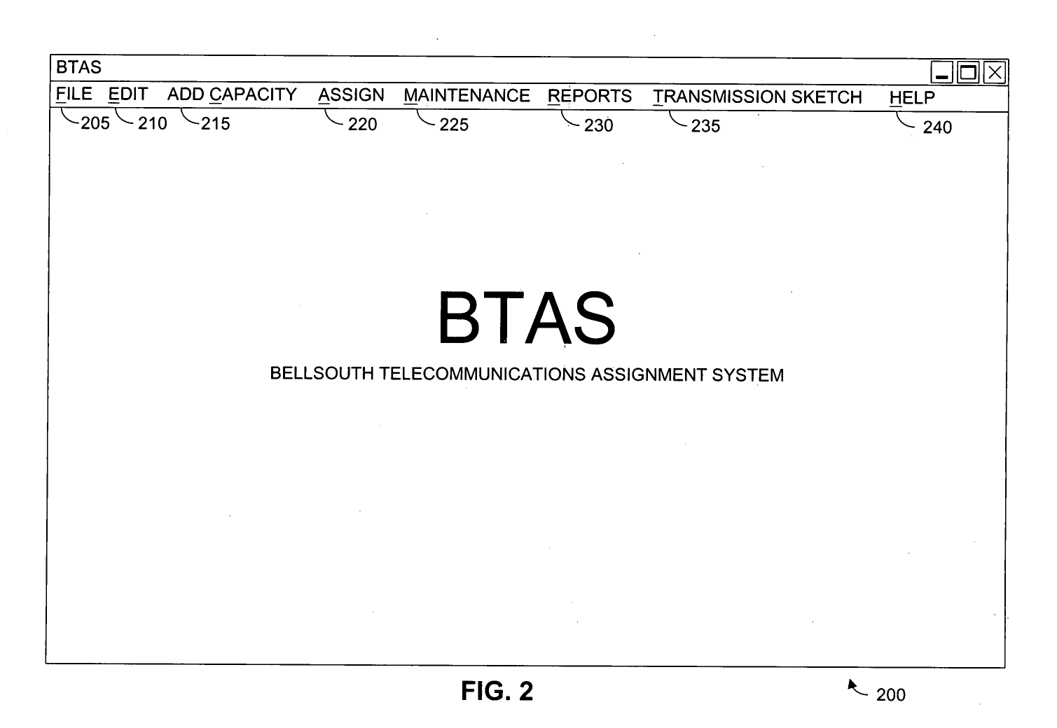

The telecommunications assignment application 180 typically operates to assign network elements 130-140 to both track alarms on the network and to assign telemetry equipment to the various network elements on the network. Moreover, the telecommunications assignment application 180 operates to provide a plurality of screen representations to a remote computer 120. Referring now to FIG. 2, shown is an embodiment, among others, of a sample screen shot of a telecommunications assignment system opening screen representation 200 as rendered by client computer 120. It should be recognized that the application 180 is preferably password protected to prevent unauthorized users from changing capacity and/or assignments.

The opening screen representation 200 typically includes a plurality of menu representations 205-240. These menu representations can include, among others: a “File” menu representation 205; an “Edit” menu representation 210; an “Add Capacity” menu representation 215; an “Assign” menu representation 220; a “Maintenance” menu representation 225; a “Reports” menu representation 230; a “Transmission Sketch” menu representation 235; and, a “Help” menu representation 240. As one skilled in the art should recognize, each of these menu representations can be selected by moving the mouse cursor representation over the menu representation and pressing the select button on the mouse.

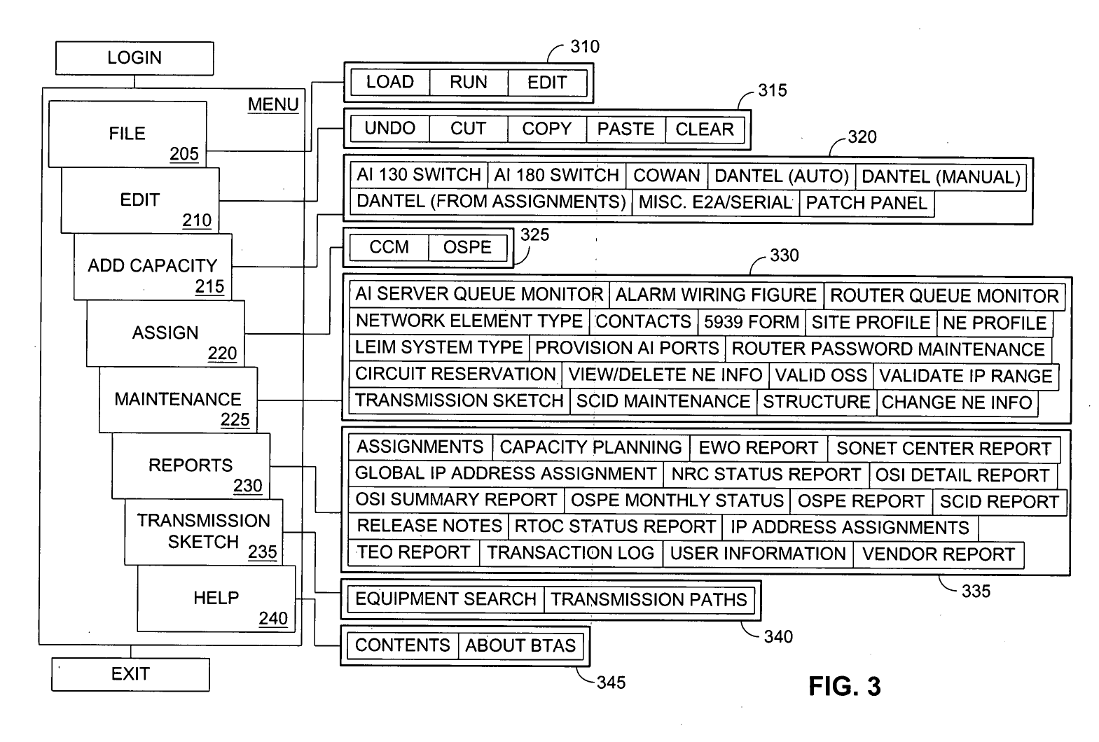

Referring now to FIG. 3, shown is a flowchart illustrating the choices presented to the user upon the user selecting any of the menu representations listed above. Upon selecting the “File” menu representation 205, a pulldown menu representation will appear with “File” selection representations 310. The “File” selection representation 310 can include, among others: a “Load” selection, a “Run” selection and an “Edit” selection. The “Load” selection enables a user to manually load a screen. The “Run” selection can typically enable a user to run a screen that was previously loaded. The “Edit” selection currently has no functionality, but could be used in some embodiments, among others, to edit a previously loaded screen.

Similarly, upon selecting the “Edit” menu representation 210, a pulldown menu representation will appear with “Edit” selection representations 315. The “Edit” selection representations 315 can include, among others: an “Undo” selection, a “Cut” selection, a “Copy” selection, a “Paste” selection, and a “Clear” selection. The “Undo” selection typically undoes the last action performed by the user. The “Cut” selection typically allows the user to “cut” a selected/highlighted piece of text from the screen representation. The “Copy” selection allows the user to store in memory a selected/highlighted piece of text from the screen representation. The “Paste” selection allows the user to “paste” a “copied” portion in memory into the space the cursor representation currently occupies. The “Clear” selection allows the user to clear the highlighted text from the screen.

Similarly, upon selecting the “Add Capacity” menu representation 215, a pulldown menu representation will appear with “Assign” selection representations 320. The “Add Capacity” selection representations 320 can include, among others: an “AI 130 Switch” selection, an “AI 180 Switch” selection, a “COWAN” selection, a “Dantel (Auto)” selection, a “Dantel (Manual)” selection, a “Dantel (from Assignments)” selection, a “Misc. E2A/Serial” selection, and a “Patch Panel” selection. Each of the selections represent alarm collection devices that can be added to the telemetry system to increase capacity.

Similarly, upon selecting the “Assign” menu representation 220, a pulldown menu representation will appear with “Assign” selection representations 325. The “Assign” selection representations 325 can include, among others: a “CCM” selection and a “OSPE” selection. “CCM” stands for circuit capacity manager, and allows the user to add telemetry capacity to the system. “OSPE” stands for outside plant engineering and allows the user to add capacity for outside plant engineering network elements.

Similarly, upon selecting the “Maintenance” menu representation 225, a pulldown menu representation will appear with “Maintenance” selection representations 330. The “Maintenance” selection representations 330 can include, among others: an “AI Server Queue Monitor” selection, an “Alarm Wiring Figure” selection, a “Router Queue Monitor” selection, a “Network Element Type” selection, a “Contacts” selection, a “5939 Form” selection, a “Site Profile, NE Profile” selection, a “LEIM System Type” selection, a “Provision AI Ports” selection, a “Router Password Maintenance” selection, a “Circuit Reservation” selection, a “View/Delete NE Info” selection, a “Valid OSS” selection, a “Validate IP Range” selection, a “Transmission Sketch” selection, a “SCID Maintenance” selection, a “Structure” selection, and a “Change NE Info” selection. The “AI Server Queue Monitor” selection typically allows users to view and update the status of AI switch provisioning. The “Alarm Wiring Figure” selection can typically enable the telecommunications assignment system project manager to add, delete, or change records that identify valid alarm wiring figures. The table can include site profile information like location type, power, standby engine, feed, and structure type. The site profile along with the multiplexer type typically indicate what alarm wiring figure to use. The “Router Queue Monitor” selection typically enables users to view and update the status of router and hub provisioning. The “Network Element Type” selection can typically enable a telecommunications assignment system project manager to add, delete, or change records that identify valid vendor and network element names so that they can be described on a “Network Element Profile” screen representation. The “Contacts” selection typically retrieve a “Contacts” screen representation which can provide users with a mechanism to create new contacts or edit existing contact information for a central office/wire center. The telecommunications assignment system 100 uses this information when creating 5939 forms. The “5939 Form” selection allows users to create 5939 Circuit Request Forms which can typically be submitted to a corporate-communication group (Corp-Com). The “Site Profile” representation provides a mechanism to create new central office, special, remote terminal, and customer premise site profiles. Users can modify or delete existing site profile records. Central office records contain telemetry related information like node type (Hub, End, or Remote), the default AI Switch location, and the serving datakit hub location. The telecommunications assignment system 100 uses this information when making telemetry assignments. The “NE Profile” representation typically enables the telecommunications assignment system project manager to add, delete, or change records that describe the telemetry methods available for a particular network element. The telecommunications assignment system 100 uses this information to make assignments and produce 5939 forms where required. The “LEIM System Type” selection enables the telecommunications assignment system project manager to add, delete, or change records that identify valid relationships between LEIM and BTAS network element names. The “Provision AI Ports” selection allows user to specify cards, or ports on a card, that they wish to have the telecommunications assignment system 100 re-provision. The “Router Password Maintenance” allows authorized users to update passwords and names associated with COWAN routers and hubs. The screen also provides the ability to have the telecommunications assignment system 100 update the passwords automatically when desired. The “Circuit Reservation” selection allows users to add or delete circuit IDs or a range of circuit IDs. The selection can also displays the status of each circuit as returned by search criteria. The “View/Delete NE Info” selection can allow users to view all telemetry assignment associated with a network element. It can also allow the user to delete a NE without first having to remove all assignments. The “Valid OSS” selection provides the telecommunications assignment system project manager with the capability to add, delete, or change records that identify valid OSS's than can be associated with an LCN that is input for a network element in a “Network Element Profile” screen representation. The “Validate IP Range” selection enables the telecommunications assignment system project manager to add, delete, or change the range of IP addresses that are associated with a particular equipment class. The telecommunications assignment system 100 uses this information when determining the list of available IP addresses for a NE assignment. The “Transmission Sketch” selection can typically be designed to enable users to create and plan network element rings. Users can view a detailed transmission drawing of the ring and manipulate network elements on the ring. A “Transmission Sketch” typically incorporates information from the telecommunications assignment system 100 and a digital service cross-connect/fiber optic cross-connect (DSX/FOX) system when creating the ring drawings. The “SCID Maintenance” selection allows users to manage the nodes that are associated with an SCID. The “Structure” selection allows the telecommunications assignment system project manager to add, delete, or change structure types. This information can then be used to populate the Site Profile screen. The “Change NE Info” selection allows user to convert an NE to a different NE Class/Vendor/NE Type/Generic combination of the same telemetry protocol.

Similarly, upon selecting the “Reports” menu representation 230, a pulldown menu representation will appear with “Reports” selection representations 335. The “Reports” selection representations 335 can include, among others: an “Assignments” selection, a “Capacity Planning” selection, an “EWO Report” selection, a “SONET Center Report” selection, a “Global IP Address Assignment” selection, an “NRC Status Report” selection, an “OSI Detail Report” selection, an “OSI Summary Report” selection, an “OSPE Monthly Status” selection, an “OSPE Report” selection, an “SCID Report” selection, a “Release Notes” selection, an “RTOC Status Report” selection, a “IP Address Assignments” selection, a “TEO Report” selection, a “Transaction Log” selection, a “User Information” selection, and a “Vendor Report” selection. Each of these selections typically generates a report based upon the category of the selection.

Similarly, upon selecting the “Transmission Sketch” menu representation 235, a pulldown menu representation will appear with “Transmission Sketch” selection representations 340. The “Transmission Sketch” selection representations 340 can include, among others: an “Equipment Search” selection and a “Transmission Paths” selection. The “Transmission Sketch” selection can typically enable users to create and plan network rings. The user can view a detailed transmission drawing of the ring and manipulate network elements on the ring. The “Transmission Sketch” screen representation typically incorporates information retrieved from the telecommunications assignment system 100 and from DSX/FOX.

Similarly, upon selecting the “Help” menu representation 240, a pulldown menu representation will appear with “Help” selection representations 345. The “Help” selection representations 345 can include, among others: a “Contents” selection and an “About BTAS” selection. The “Contents” selection will typically allow-the user to search for a help topic, while the “About BTAS” selection will give the users information about the BTAS program.

One skilled in the art should recognize that the menu system recited above is only an example of one of many menu systems that could be used in conjunction with the telecommunications assignment system 100. It should be clear that there exist numerous other telemetry devices that could be added to the menu, other types of reports that could be included, other maintenance topics, etc. that could be included within the scope of the present disclosure. Thus, each of these alternative menu designs is intended to be included within the scope of the present disclosure.

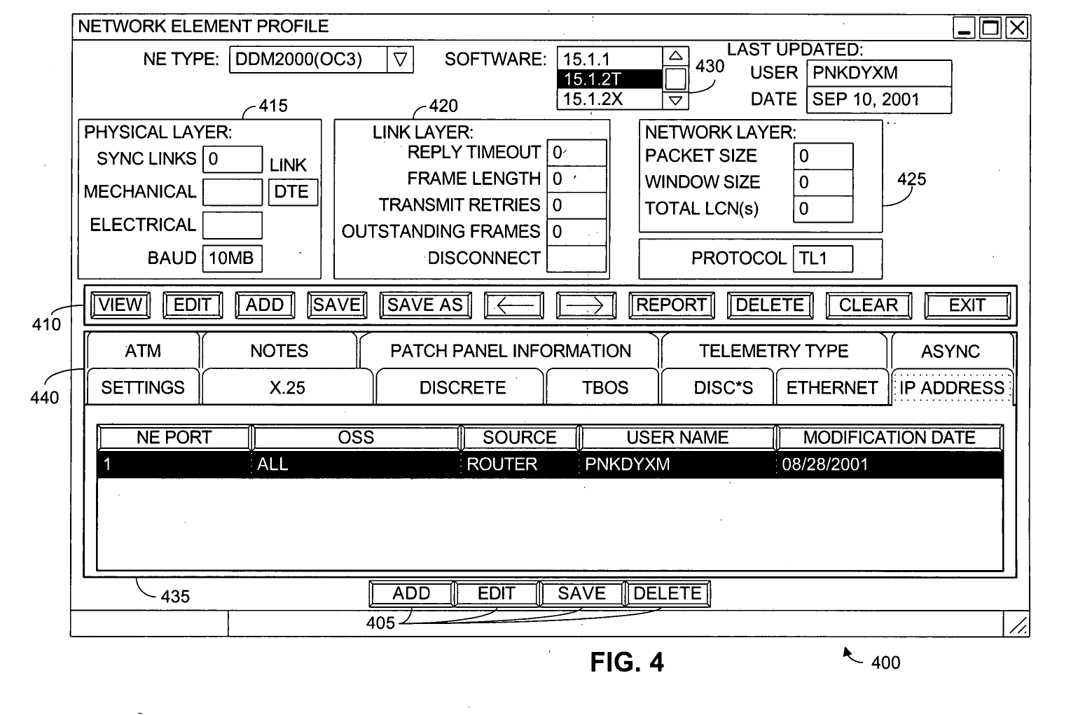

Referring now to FIG. 4, shown is an embodiment, among others, of a sample screen shot of a network element profile. This screen representation 400 can typically be accessed by selecting the “NE profile” selection under the “Maintenance” menu representation 225. The profile shown is for a DDM2000 network element. The DDM2000 is an OC3 multiplexer available from Lucent Technologies, of Murray Hill, N.J. From this window the user can create and modify the types of network elements that can be tracked using telemetry equipment. Similarly, any other network elements on which the user wishes to track telemetry can be added to the system by adding a profile here. The button representations 405, 410 allow the user to request the various changes that can be made to a network element. The field representations 415, 420, 425, 430 allow the user to enter various types of information into the database 182, such as software, physical layer connections, link layer configurations, and network layer configurations. The tabbed field representation 435 allows the user to enter further information regarding the network element profile according to which of the plurality of tab representations 440 is selected. On the screen representation 400 shown, the “IP Address” tab is selected. Thus, the user is able to view information about the network element IP address. Each of the tab representations 440 allow the user to configure a different field associated with the network element.

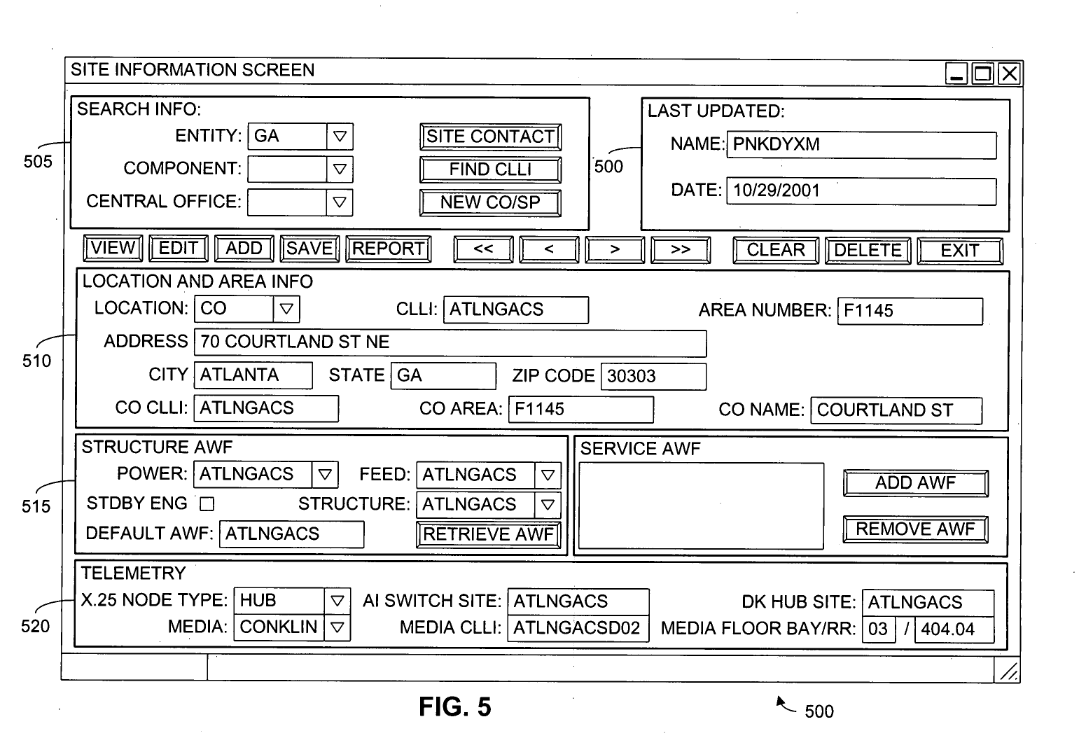

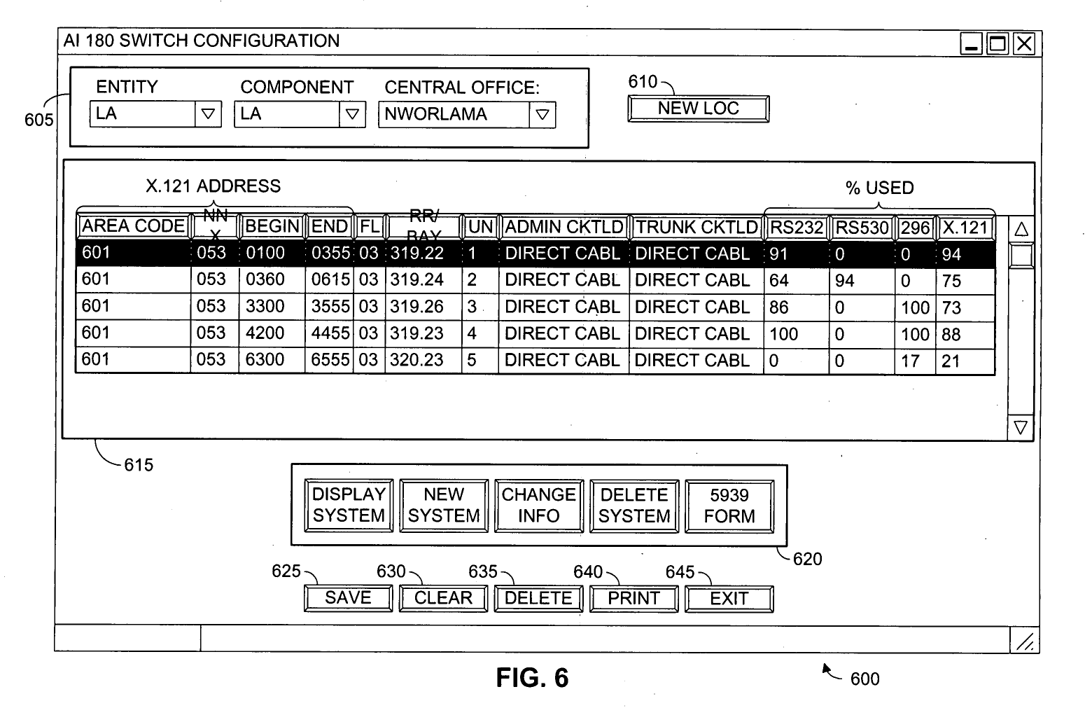

Referring now to FIG. 5, shown is an embodiment, among others of a screen shot of a “Site Information Screen” representation 500. The “Site Information Screen” representation 500 allows the user to search for various central offices (COs) according to search parameters specified by the user. Typically the user would enter the information regarding the CO into the “Search” field representation 505. The telecommunications assignment system 100 would then retrieve a CO matching the CO specified by the search terms entered into the “Search” field representation 505. The location and address of the CO would typically populate the “Location” field representation 510. The “Structure AWF” field representation 515 would typically allow the user to retrieve alarm wiring figures (AWF) associated with the CO. The “Telemetry” field 520 would allow the user to view information about the telemetry equipment located at the CO. Referring now to FIG. 6, shown is an embodiment, among others, of a sample screen shot of an “AI 180 Switch Configuration” screen representation 600. The “AI 180 Switch Configuration” screen representation 600 allows the user to view the configuration of the AI 180 switches associated with a CO. AI 180 switches are alarm collectors which are widely used in the telecom industry, and are available from Applied Innovation, Inc., of Dublin, Ohio. The user would typically search for these switches by entering search parameters into the search field 605. Upon entering the search parameters into the search field 605, the user would typically select the “Retrieve Systems” button representation 620.

Upon selecting the “Retrieve Systems” button representation 620, the client computer 120 would retrieve information about AI 180 switches matching the search parameters from the teleconmunications assignment system database 182. Upon receiving the information from the telecommunications assignment system database 182 the client would display the search results in a results pane representation 615. The user may select any of the AI 180 switches returned by the search, and display, modify, or delete the system using button representations 620. The user choose to create a new system or submit a 5939 form using the button representations 620. Furthermore, the “AI 180 Switch Configuration” screen representation 600 further includes a plurality of button representations that can include, among others: a “Save” button representation 625, a “Clear” button representation 630, a “Delete” button representation 635, a “Print” button representation 640, and an “Exit” button representation 645. The “Save” button representation 625 is operable to command the database 182 to store any changes the user has made. The “Clear” button representation 630 is operable to clear the fields on the screen representation 600. The “Delete” button representation 635 is operable to instruct the database 182 to remove the currently selected record from memory. The “Print” button representation 640 is operable to instruct the client computer to print the screen representation out to a connected printer or to a file. The “Exit” button representation is operable to instruct the screen to close.

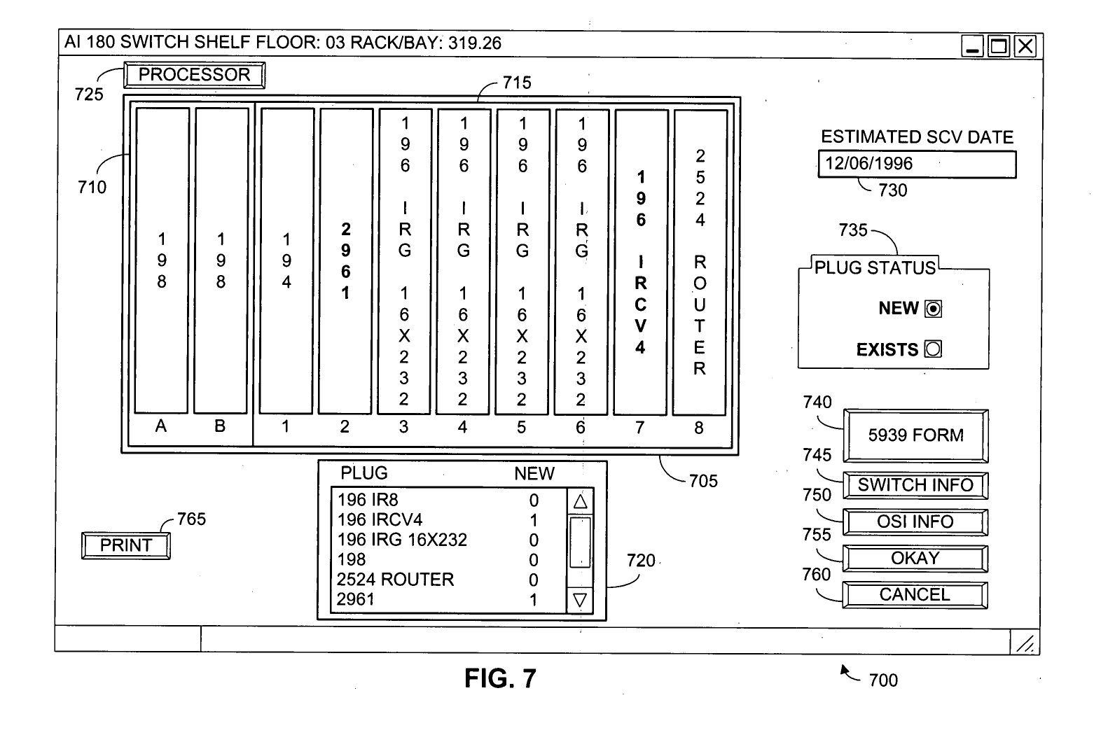

Referring now to FIG. 7, shown is an embodiment, among others, of a sample screen shot of an “AI 180 Switch Shelf“ screen representation 700. The “AI 180 Switch Shelf” screen representation 700 is obtained by selecting the display system button representation of FIG. 6. The screen representation 700 includes a graphical representation 705 of the AI 180 switch. One skilled in the art should immediately recognize that the graphical representation of the AI 180 switch includes the same organization as the physical AI 180 switch. In particular, the graphical representation 705 includes a processor section representation 710 and an interface card section representation 715. The processor section representation 710 includes two slots for cards. In the present example, among others, the processor section comprises two “198” processor cards. The 198 processor card is a standard processor card that is available from Applied Innovation, Inc. The interface card section representation can include up to eight network interface cards in slots numbered 1 to 8. Moreover, the new cards appear in bold, and in the plug-in list representation 720.

The user can also change the cards installed at the switch by moving the mouse cursor representation over the card and clicking the left button. Similarly the user can switch processor cards by moving the mouse cursor representation over the processor card, and selecting to remove the processor. The processor can also be changed by selecting the “Processor” button representation 725. Upon selecting the “Processor” button representation 725, a screen representation can appear to enable the user to choose the processor type.

The screen representation 700 also includes a plurality of other fields and button representations. The “Estimated Svc. Date” field representation 730 includes the estimated service date for the AI 180 switch. The “Plug Status” field representation 735 alerts the user as to the status of the currently selected network interface card representation. The plurality of button representations 740-760 can include, among others: a “5939 Form” button representation 740, a “Switch Info” button representation 745, an “OSI Info” button representation 750, an “Okay” button representation 755, a “Cancel” button representation 760, and a “Print” button representation 765. The “5939 Form” button representation 740 allows the user to submit a 5939 form. The 5939 form is a form that is typically sent to corporate command to establish a data circuit. The “Switch Info” button 745, when selected, produces a screen with information about the AI 180 switch. The “OSI Info” button representation 750, when selected, will produce OSI information regarding the AI 180 switch. The “Okay” button representation 755, when selected, will save the information that was changed by the user. The “Cancel” button, when selected, will cancel any changes made by the user. The “Print” button representation 765 allows the user to print the current configuration of the AI 180 switch in the graphical “Shelf” form.

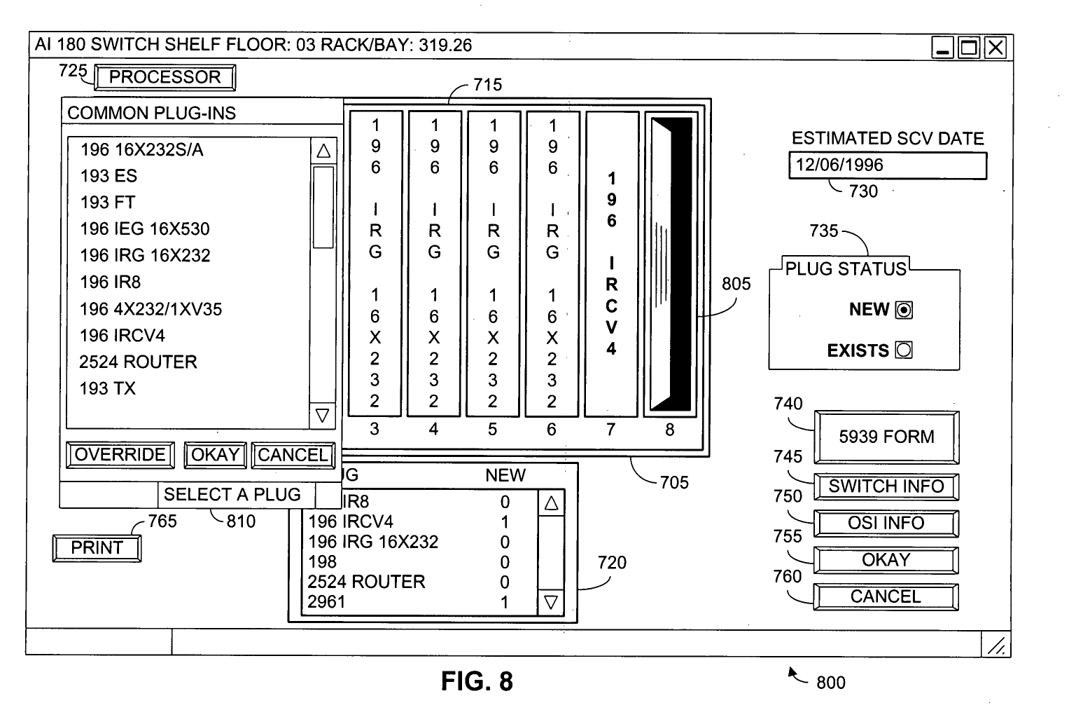

Referring now to FIG. 8, shown is a sample screen shot of an embodiment, among others, of an add card screen representation 800. The screen representation 800 is similar to the “AI 180 Switch Shelf” screen representation, however, the card in the last slot 805 has been removed. In order to add a card to the AI 180 switch, the user would move the mouse cursor representation over the empty slot and press the left mouse button to obtain a menu. The user would then select the add card option from the menu. A “Common Plug-Ins” window representation 810 would appear. The user could then move the mouse cursor over any of the plug-ins listed and select the plug-in by pressing the left mouse button. By selecting the “Okay” button representation from the “Common Plug-Ins” window representation 810, the card would appear in the empty slot 805. If the user selected the “Cancel” button representation, the empty slot 805 would remain empty. The “Override” button representation typically enables administrators to override a telecommunications assignment system rule that removes port assignments before the card type can be changed. An administrator can thus select a new card and the new card will have the same assignments as the old card (provided that the card has the same port types).

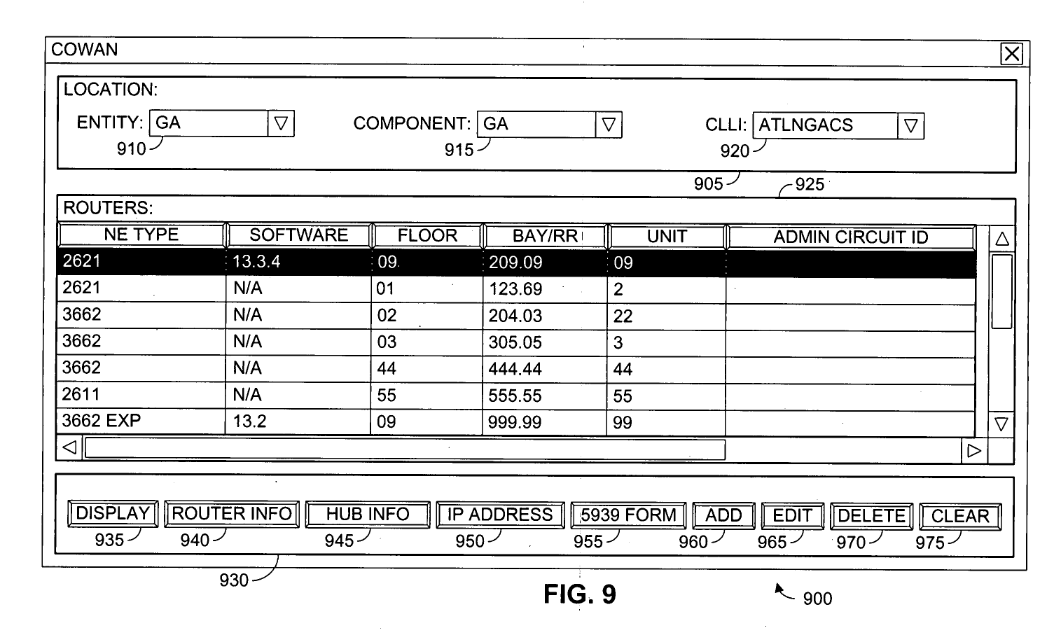

Referring now to FIG. 9, shown is a sample screen shot of an embodiment, among others, of a “COWAN” screen representation 900. This screen is typically accessed by selecting the “Add Capacity” menu representation 215 on the opening screen representation 200 and then selecting the “COWAN” selection as shown in FIG. 3. The user can view all of the routers contained at a central office using the “COWAN” screen representation 900. Typically the user would enter search parameters into the location field representations 905. Particularly, the user typically enters parameters into the “Entity” field representation 910, the “Component” field representation 915, and the “CLLI” field representation 920. After entering these parameters, the search results will appear in the “Routers” data table representation 925.

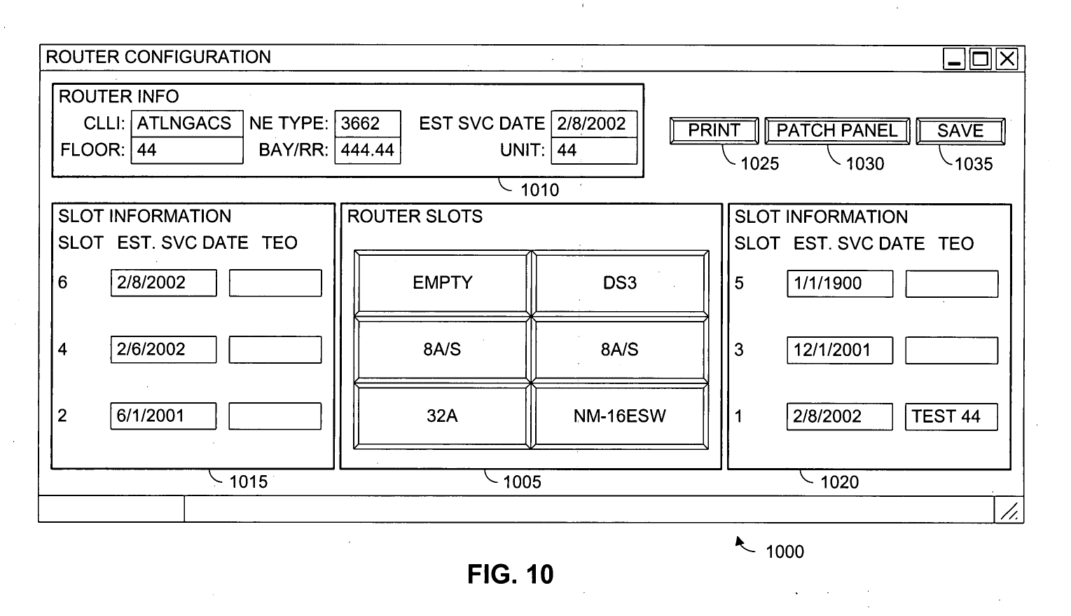

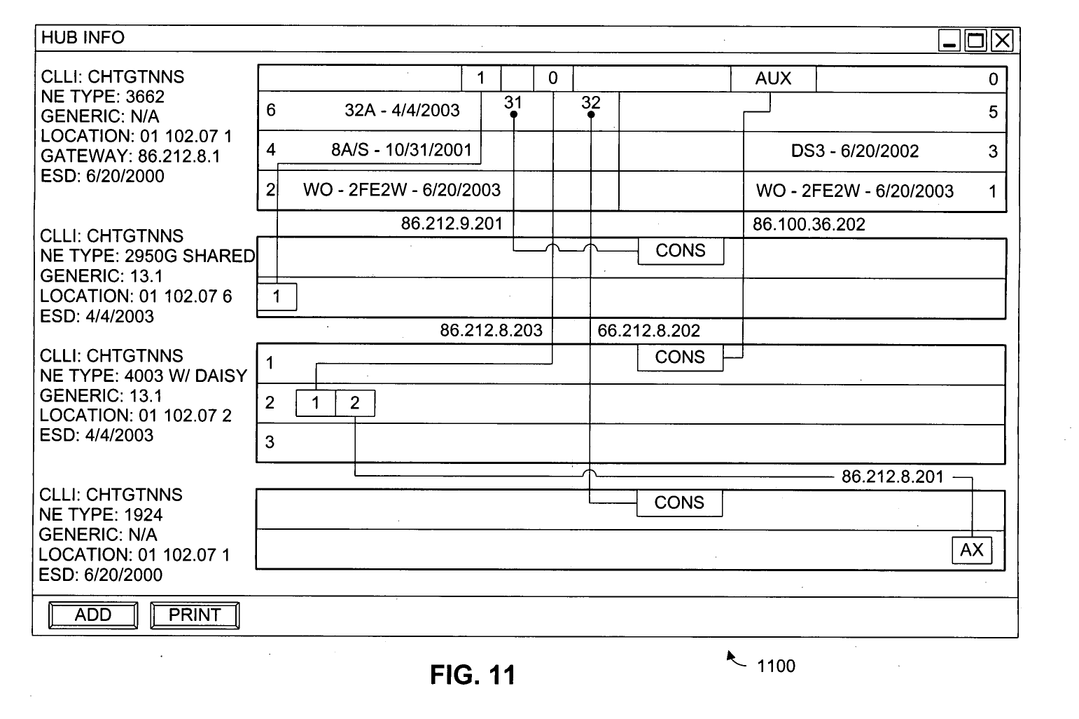

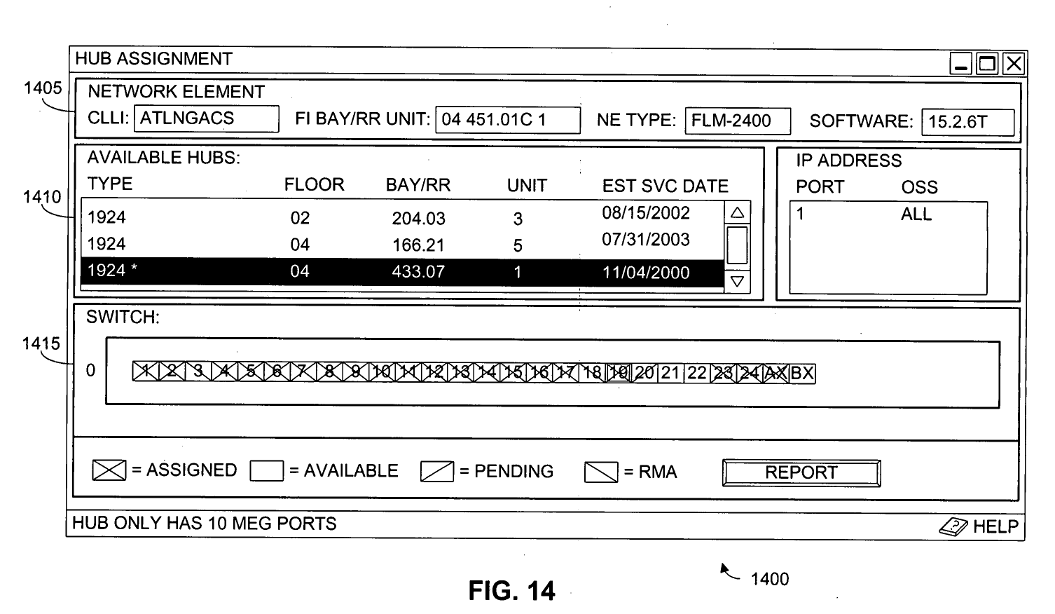

The user can also use the button representations 930 to request the client perform some action. These button representations 930 can include, among others: a “Display” button representation 935, a “Router Info” button representation 940, a “Hub Info” button representation 945, an “IP Address” button representation 950, a “5939 Form” button representation 955, an “Add” button representation 960, an “Edit” button representation 965, a “Delete” button representation 970, and a “Clear” button representation 975. The “Display” button representation 935 typically displays the highlighted router in graphical form as shown in FIG. 10. The “Router Info” button representation 940 typically displays information about the highlighted router. The “Hub Info” button representation 945 typically retrieves a diagram of the highlighted Router's connection to any connected Hub(s) as shown in FIG. 11. Moreover, the diagram allows the user to select and view a graphical representation of a Hub, as shown in FIG. 14. The “IP Address” button representation 950 allows the user to view IP addresses associated with the highlighted router. The “5939 Form” button representation 955 allows the user to submit a 5939 form as described above. The “Add” button representation 960 allows the user to add a router to the central office. The “Edit” button representation 965 allows the user to enter information to edit a profile associated with the highlighted router. The “Delete” button representation 970 allows the user to delete the highlighted router. The “Clear” button representation 975 allows the user to clear the “Location” search fields 905 and the search results 925 before performing a new search.

Referring now to FIG. 10, shown is a sample screen shot of an embodiment, among others, of a “Router Configuration” screen representation 1000. This screen representation 1000 is typically accessed by selecting the “Display” button representation 935 of FIG. 9. The “Router Configuration” screen representation 1000 allows the user to view the cards installed in a router. Like FIGS. 7 and 8, the cards are presented in a graphical representation 1005. Similarly, the graphical representation 1005 is configured substantially similar to the physical layout of the Cisco 3662 router shown in this example, among others. The Cisco 3662 router is a common router available from Cisco Systems, Inc., of San Jose, Calif. The Cisco router has six slots, numbered from right to left, bottom to top, respectively.

The “Router Configuration” screen representation 1000 can also include, among others: “Router Info” field representations 1010, “Slot Information” field representations 1015, 1020, and button representations “Print” 1025, “Patch Panel” 1030, and “Save” 1035. The “Router Info” field representations 1010 typically include various information about the router whose configuration is displayed. The “Slot Information” field representations 1015, 1020 typically include information regarding each of the slots on the router. The “Print” button representation 1025 allows the user to print the router configuration. The “Patch Panel” button representation allows the user to view the patch panels installed in the current central office. The “Save” button representation 1035 allows the user to save any changes made to the router configuration.

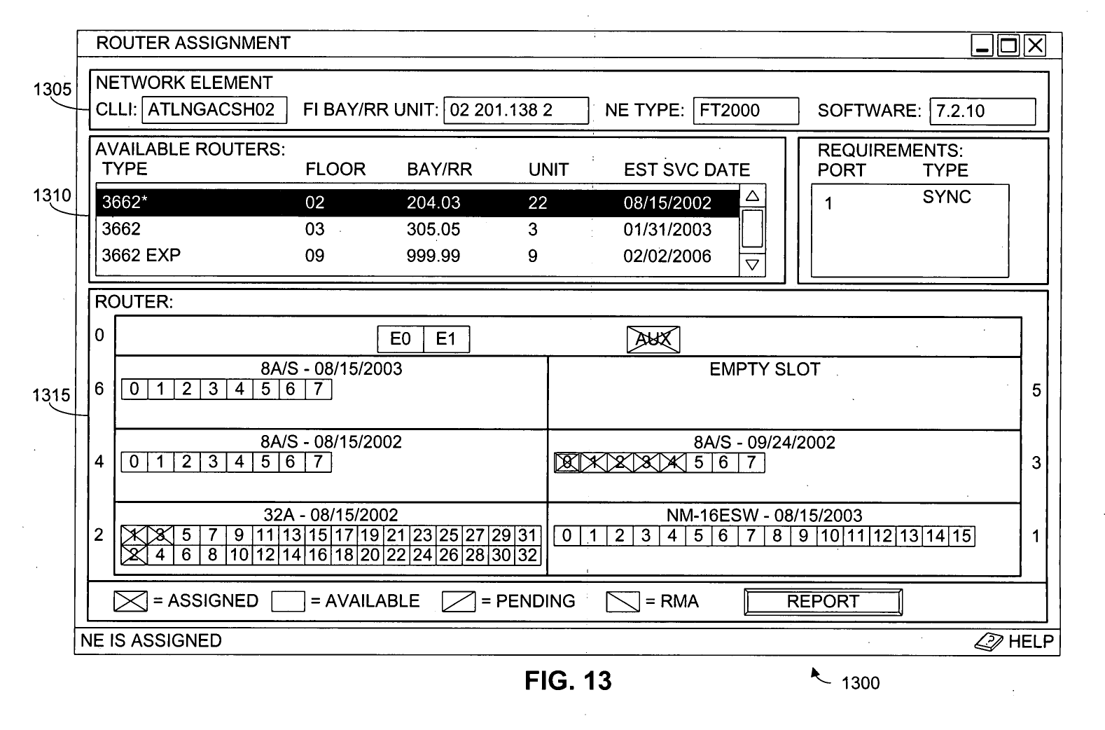

Referring now to FIG. 11, shown is a screen shot of an embodiment, among others, of a “Hub Info” screen representation 1 100. The “Hub Info” screen representation shows a schematic of the hubs connected to the router highlighted on the “COWAN” screen representation 900. The “Hub Info“screen representation 1100 also includes the IP addresses of each of the connections between the router and the hubs. Furthermore, the “Hub Info” screen representation 1100 includes information about the location of each of the hubs and the router. This information includes the CLLI code of the CO, the type of hub/router, the software being used on the hub/router, the floor/bay/RR/unit number, and the estimated service date. The user can view more details of any of the hub(s) or router by moving the mouse cursor representation over the desired unit and pressing the right mouse button to produce a menu representation. Typically the menu representation will include a variety of options for the user. In particular the menu representation includes, among others, a view assignments selection. The view assignments selection can be used to view the assignments of a hub/router/patch panel as shown with respect to FIGS. 13-15.

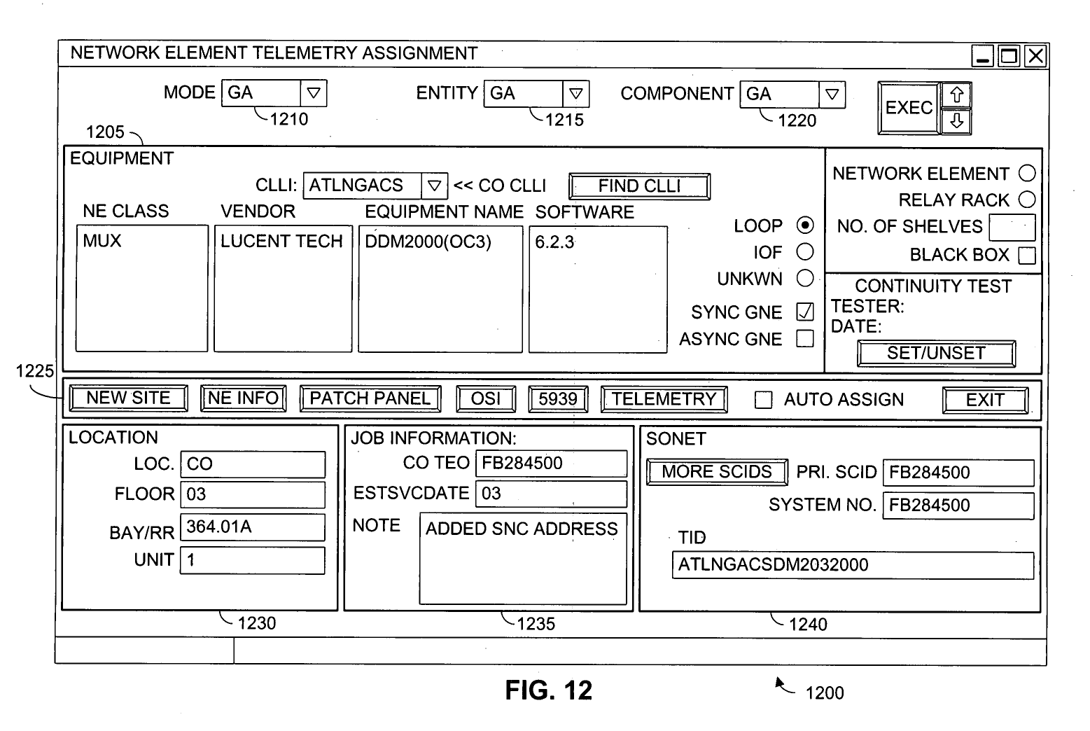

Referring now to FIG. 12, shown is a screen shot of an embodiment, among others, of a “Network Element Telemetry Assignment” screen representation 1200. Typically the user could locate network elements at a CO using the “Mode,” “Component,” and “Entity” field representations 1210, 1215, 1220, respectively, and the “Equipment” pane representation 1205 to select the CO CLLI code.

The “Network Element Telemetry Assignment” screen representation 1200 also includes a plurality of button representations 1225, including, among others: a “New Site” button representation, an “NE Info” button representation, a “Patch Panel” button representation, an “OSI” button representation, a “5939” button representation, a “Telemetry” button representation, and an “Exit” button representation. The “New Site” button representation typically allows a user to request that a new CLLI code be added to the telecommunications assignment system database 182. The “NE Info” button representation typically allows the user to view information about the selected network element (NE). The “Patch Panel” button representation allows the user to view the patch panel to which the NE is connected. The “OSI” button representation allows the user to view the OSI card to which a network element is connected. The “5939” button representation allows the user to submit a 5939 form as described above. The “Telemetry” button representation allows the user to assign telemetry elements to the selected NE. The “Exit” button representation allows the user to exit the current screen representation.

The “Network Element Telemetry Assignment” screen representation can also typically include, among others: “Location” field representations 1230, “Job Information” field representations 1235, and SONET information field representations 1240. The “Location” field representations 1230 specifies the location of the network element. The “Job Information” field representations 1235 typically includes information about the TEO and estimated service date. The SONET information field representations include information about the SCID associated with the network element and the target identifier (TID) of the network element.

Referring now to FIG. 13, shown is a sample screen shot of an embodiment, among others, of a “Router Assignment” screen representation 1300. The “Router Assignment” screen representation 1300 can typically include, among others: “Network Element” field representations 1305, “Available Routers” field representation 1310, and a graphical representation 1315 of the router highlighted in the “Available Routers” field representation 1310. Again, one skilled in the art should recognize that the graphical representation 1315 of the router is substantially similar to the physical layout of a real Cisco 3662 router. Moreover, even the cards installed into the 3662 router contain the correct layout to match the layout of the physical cards. The graphical representation 1315 farther includes notation at each of the card ports as to whether the card is “Assigned,” “Available,” “Pending,” or “RMA” (Requires Manual Attention). A user can “mouse over” any of the ports to determine what network element is assigned to that port. Furthermore, the user can assign the network element listed in the “Network Element” field representations 1305 to a selected port of the router.

Referring now to FIG. 14, shown is a sample screen shot of an embodiment, among others, of a “Hub Assignment” screen representation 1400. The “Hub Assignment” screen representation 1400 can typically include, among others: “Network Element” field representations 1405, “Available Hubs” field representation 1410, and a graphical representation 1415 of the hub highlighted in the “Available Hubs” field representation 1410. Again, one skilled in the art should recognize that the graphical representation 1415 of the hub is substantially similar to the physical layout of a real 1924 hub. The 1924 hub is available from Cisco Systems, Inc. of San Jose, Calif. The graphical representation 1415 further includes notation at each of the ports of the hub as to whether the card is “Assigned,” “Available,” or “Pending.” A user can “mouse over” any of the ports to determine what network element is assigned to that port. Furthermore, the user can assign the network element listed in the “Network Element” field representations 1405 to a selected port of the hub.

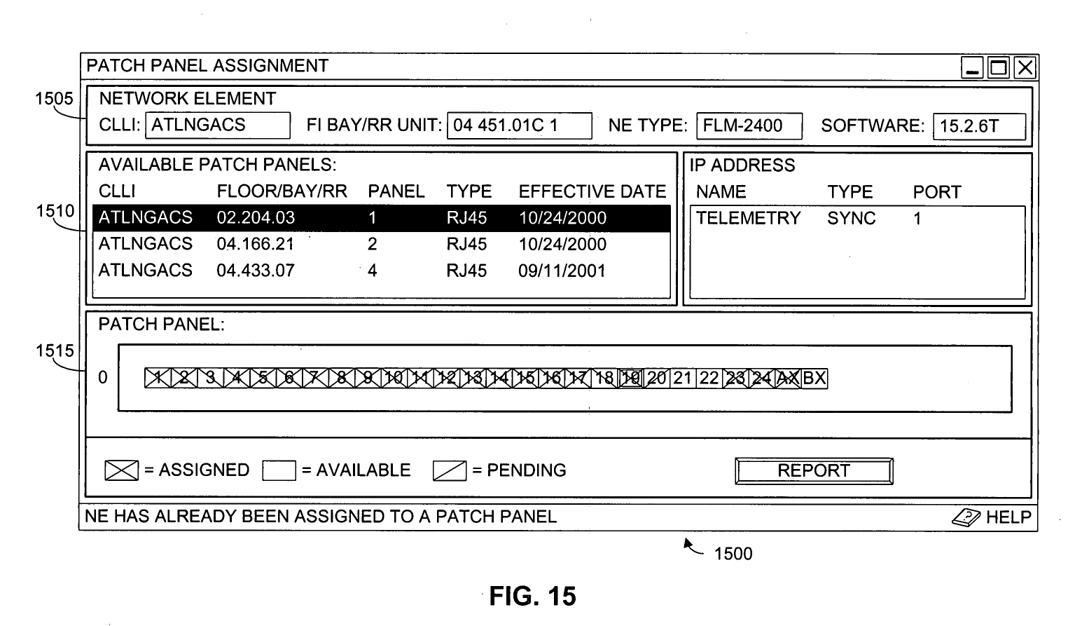

Referring now to FIG. 15, shown is a sample screen shot of an embodiment, among others, of a “Patch Panel Assignment” screen representation 1500. The “Patch Panel Assignment” screen representation 1500 can typically include, among others: “Network Element” field representations 1505, “Available Patch Panels” field representation 1510, and a graphical representation 1515 of the patch panel highlighted in the “Available Patch Panels” field representation 1510. Again, one skilled in the art should recognize that the graphical representation 1515 of the patch panel is substantially similar to the physical layout of a real patch panel. The graphical representation 1515 further includes notation at each of the ports of the patch panel as to whether the card is “Assigned,” “Available,” or “Pending.” A user can “mouse over” any of the ports to determine what network element is assigned to that port. Furthermore, the user can assign the network element listed in the “network Element” field representations 1505 to a selected port of the patch panel.

It should be recognized by one skilled in the art that graphical models for any assignments screens can be similarly added to the telecommunications assignment system 100. In particular, the graphical representations can help technicians troubleshoot a problem more easily than a text representation. Further, a network planner can more accurately design systems and plan for future needs using the graphical representations of the network elements.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should also be emphasized that the above-described embodiments of the present disclosure are merely possible examples of implementations set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

1. A telecommunications assignment system, comprising:
assignment logic operable to assign a plurality of telecommunications equipment and ports to a plurality of network elements;
collection logic operable to receive assignments from the assignment logic and store the assignments in a database;
graphical user interface logic operable retrieve assignments from the database, and to display the assignments to a user in a graphical format which includes displaying the telecommunications equipment in a graphical format substantially similar to a physical construction of the telecommunications equipment.

2. The system of claim 1, wherein the graphical user interface logic is further operable to display the plurality of network elements in a graphical format substantially similar to a physical construction of the network element.

3. The system of claim 1, wherein the graphical user interface logic is operable to provide the graphical format to a remote client on a computer associated with the user over a network.

4. The system of claim 3, wherein the remote client is a web browser operable to view any of a plurality of web formats.

5. The system of claim 3, wherein the remote client is a telecommunications assignment system application.

6. The system of claim 1, wherein the assignment logic is operable to remove assignments, add assignments, remove cards, and add cards on the telecommunications equipment.

7. The system of claim 6, wherein the assignment logic is operable to track cards installed into telecommunications equipment.

8. The system of claim 1, wherein the database is a centralized database which is further operable to store telecommunication equipment and network element graphical format configurations.

9. A method of assigning telecommunications equipment, comprising:
providing a graphical user interface to a user, the graphical user interface comprising a plurality of telecommunications equipment and network elements which are displayed to the user in a format substantially similar to the physical construction of the telecommunications equipment, the graphical user interface being further operable to allow the user to make telecommunication equipment assignments;
receiving telecommunications equipment assignments from the user via the graphical user interface; and
storing the telecommunications equipment assignments received from the user in a database for later retrieval.

10. The method of claim 9, wherein the format for the telecommunications equipment and network elements display are stored in the database with the telecommunications equipment assignments.

11. The method of claim 9, further comprising:
providing the graphical user interface to the user over a network to a remote client associated with the user.

12. The method of claim 11, further comprising using a web browser as the remote client, the web browser being operable to view any of a plurality of web formats.

13. The method of claim 11, further comprising using a telecommunications assignment application as the remote client.

14. The method of claim 9, wherein the graphical user interface is operable to allow the user to remove cards, add cards, remove assignments, and add assignments on the telecommunications equipment.

15. The method of claim 14, wherein graphical user interface is further operable to allow the user to change plug-in cards installed into the telecommunications equipment.

16. The method of claim 9, wherein the database is a centralized database which is operable to provide assignment information and display information to the user.

17. A computer readable medium having a program for assigning telecommunications equipment, the program operable to perform the steps of:
providing a graphical user interface to a user, the graphical user interface comprising a plurality of telecommunications equipment and network elements which are displayed to the user in a format substantially similar to the physical construction of the telecommunications equipment, the graphical user interface being further operable to allow the user to make telecommunication equipment assignments;
receiving telecommunications equipment assignments from the user via the graphical user interface; and
storing the telecommunications equipment assignments received from the user in a database for later retrieval.

18. The program of claim 17, wherein the format for the telecommunications equipment and network elements display are stored in the database with the telecommunications equipment assignments.

19. The program of claim 17, further comprising:
providing the graphical user interface to the user over a network to a remote client associated with the user.

20. The program of claim 19, further comprising using a web browser as the remote client, the web browser being operable to view any of a plurality of web formats.

21. The program of claim 19, further comprising using a telecommunications assignment application as the remote client.

22. The program of claim 17, wherein the graphical user interface is operable to allow the user to remove ports, remove assignments, and create alarms on the telecommunications equipment.

23. The program of claim 22, wherein graphical user interface is further operable to allow the user to change plug-in cards installed into the telecommunications equipment.

24. The program of claim 17, wherein the database is a centralized database which is operable to provide assignment information and display information to the user.
